(19) United States
(12) Patent Application Publication
(10) Pub. No.: US 2009/0214814 A1
(43) Pub. Date: Aug. 27, 2009

(54) SLIP-RESISTANT COATING SYSTEM FOR WOOD PRODUCTS

(75) Inventors: Mark D. Rintoul, JR., High Point, NC (US); Herbert D. Temple, Archdale, NC (US)

Correspondence Address: IPLM GROUP, P.A., POST OFFICE BOX 18455, MINNEAPOLIS, MN, 55418, US

(73) Assignee: Valspar Sourcing, Inc.

(21) Appl. No.: 12/357,873

(22) Filed: Jan. 22, 2009

Related U.S. Application Data
(63) Continuation of application No. PCT/US2007/074234, filed on Jul. 24, 2007.
(60) Provisional application No. 60/832,837, filed on Jul. 24, 2006.

(51) Int. Cl. B32B 5/02; C08J 7/18; B32B 21/08; B32B 27/04; B32B 21/12; C09K 3/14

(52) U.S. Cl. 428/106; 427/487; 427/510; 427/504; 428/141; 428/147; 428/143; 106/36

(57) ABSTRACT

The present invention provides a method for preparing a slip-resistant surface on an engineered wood product. The method includes the steps of (i) providing an engineered wood product (panel), (ii) applying a slip-resistant surface coating system, which includes a liquid radiation-curable coating composition and a texturing agent, to at least a portion of at least one surface of the wood product (panel); and (iii) curing the composition. In a preferred embodiment the coating composition is substantially free of solvent and radiation-curable. The coating composition may be applied in one or more layers, and the coating composition is in the form of a UV-curable coating composition.

### CROSS-REFERENCE TO RELATED APPLICATION

This application is a continuation of international applicant PCT/2007/074234, filed Jul. 24, 2007 and published as WO/2008/014267 on Jan. 31, 2008, which claims priority from U.S. Provisional Application Ser. No. 60/832,837, filed Jul. 24, 2006, the disclosures of which are incorporated herein by reference.

### TECHNICAL FIELD

The present invention is related to a coating system useful in the manufacturing of engineered wood products, such as oriented strand board (OSB) panels with improved slip-resistance. The improved slip-resistance provides an improvement in safety when the panels are used for roof panels.

### BACKGROUND

Engineered wood products, such as oriented strand board (OSB), fiberboard, plywood and laminated veneer lumber (LVL), are being widely used in residential and commercial construction, and are gaining popularity in markets such as homes, particularly for use in roofs. The products used in roofing, e.g., panels, typically have a pattern applied to one surface during the manufacturing process. These panels are available in a variety of products such as oriented strand board (OSB) panels, plywood, medium density fiberboard (MDF), laminated veneer lumber (LVL) products, and the like.

Engineered wood products are typically manufactured from small pieces of wood and heat-cured with adhesives. For example, oriented strand board (OSB) panels are manufactured from heat-cured adhesives and rectangular-shaped wood strands that are arranged in cross-oriented layers to form mats. The mats are trimmed to a manageable size and then the wood strands and glue are bonded together under heat and pressure in a press. These are commonly referred to as engineered structural panels and have uses that include roof sheathing, wall sheathing, and in flooring systems for residential home construction.

Plywood is made from thin wood veneers stripped from logs. The veneers are glued together under heat and pressure in a press to form panels.

These materials can be used as roofing panels for commercial and residential buildings by attaching the panels to the rafters of an underlying supporting structural frame. However, the surface of the panels can be slippery. Thus, for panels used in roofing applications, where workers may have to walk on the surface of the panels the addition of a slip-resistant (anti-skid) texture to improve worker safety may be desired. Typically, a slip-resistant surface can be applied to engineered wood panels during the manufacturing process by imprinting methods, such as using a screen back press to imprint a slip-resistant surface on the board. The screen back press can use a screen mesh to provide a slip-resistant surface. During the heating cycle, the screen can emboss the surface of the panels in the press, to provide a slip-resistant surface. However, this method can add additional cost to the wood product. The use of a screen back press can lead to additional expenses related to screen tears, screen wear, production downtime, increased press temperatures, increased press dwell times and additional cleaning due to formation of resin balls that can stick to the screens. This screen imprinting can increase processing times and may require higher press temperatures. The requirement for a slip-resistant surface is typically required only on roofing panels and is not normally required for wall or floor panels.

The screen imprint is usually applied when the panels are hot, during the press cycle. The use of a slip-resistant coating system on all or a portion of a panel surface could eliminate the need for using the screen imprint process. However, it can be difficult to apply a slip-resistant coating while the panels are hot, after coming off a press. The use of heat cure coatings or solvent (e.g., either organic solvents or water) containing coatings may require that the panels be cooled prior to application of the slip-resistant coating system.

Thus, there is a need for a method to prepare slip-resistant surfaces that will allow the manufacturers to eliminate screen plates, and reduce the cost associated with the screen press process for manufacturing engineered wood products. Accordingly, there is a need for a slip-resistant surface coating system for engineered wood panels that can be applied to the panels shortly after the panels emerge from the hot presses.

### SUMMARY

The present invention provides a method for preparing a slip-resistant surface on an engineered wood product. The method includes the steps of (i) providing an engineered wood product (e.g., panel), (ii) applying a slip-resistant surface coating system, which includes a liquid radiation-curable coating composition and a texturing agent, to at least a portion of at least one surface of the wood product (panel); and (iii) curing the composition. The coating system may be applied in one or more layers, and is in the form of a UV-curable coating composition.

In another embodiment, the coating composition is substantially free of volatile solvents or carriers.

In another embodiment, the invention provides a method for coating an article, including, an engineered wood product, wherein the coating system includes a liquid radiation-curable coating composition and a texturing agent. In a preferred embodiment, the coating composition is substantially free of solvents or carriers. The coating system may be applied in one or more layers, and is in the form of a UV-curable coating composition.

In another embodiment, the invention provides coated articles, wherein the article is or is made from an engineered wood product. The article has a slip-resistant surface coating system applied to at least one surface of the substrate, wherein the slip-resistant surface coating system includes a radiation-curable coating composition and a texturing agent. In another embodiment, the coating composition is substantially free of solvents or carriers and may be applied in one or more layers.

In another embodiment, the invention provides a slip-resistant surface coating system for preparing a slip-resistant surface on an engineered wood product. The coating system includes a radiation-curable coating composition and a texturing agent. In another embodiment, the coating composition is substantially free of solvents or carriers. The coating system may be applied in one or more layers.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a view of a section of an OSB panel having the slip-resistant system applied in the form of stripes.

FIG. 2 shows a close-up view of a section of an OSB panel having the slip-resistant system applied in the form of stripes.

### DETAILED DESCRIPTION

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “a,” “an,” “the,” “at least one,” and “one or more” are used interchangeably. Thus, for example, a coating composition that contains “an” additive means that the coating composition includes “one or more” additives.

The recitation of a numerical range using endpoints includes all numbers subsumed within that range (e.g., 1 to 5 includes 1, 1.5, 2, 2.75, 3, 3.80, 4, 5, etc.).

The terms “engineered wood product”, “engineered wood composite” and “engineered wood composite material” generally refer to products or articles that are prepared from pieces of wood such as sheets, chips, flakes, fibers, rectangular-shaped wood strands (e.g., rectangular-shaped wood strands), saw dust, and the like. The pieces are typically bonded together, often with an adhesive. Non-limiting examples of wood composite materials include oriented strand board (“OSB”), waferboard, particle board, chipboard, medium-density fiberboard, plywood, and panels that are a composite of strands and ply veneers. The terms “flakes”, “strands”, “sheets”, “chips” and “wafers” are considered equivalent to one another and may be used interchangeably.

The present invention provides a method for preparing a slip-resistant surface coating on an engineered wood article wherein the method includes the steps of applying a slip-resistant surface coating system, which includes a coating composition and a texturing agent, to at least a portion of at least one surface of the article and curing the coating composition. In one embodiment, the coating composition is substantially free of solvent and radiation-curable. The slip-resistant surface coating system can be applied to engineered wood products (e.g., panels) that have been just removed from a press and are still hot. The temperature of the panels can be from about 24° C. (75° F.) to about 149° C. (300° F.). Preferably, the temperature of the panels can be from about 52° C. (125° F.) to about 135° C. (275° F.). More preferably, the temperature of the panels can be from about 66° C. (150° F.) to about 121° C. (250° F.). Even more preferably, the temperature of the panels can be from about 93° C. (200° F.) to about 107° C. (225° F.).

The present invention also provides a slip-resistant surface coating system for an article, such as an engineered wood panel. Preferably, the slip-resistant system includes a coating composition and a texturing agent. In one embodiment, the surface coating system includes one or more coating compositions that may be applied in one or more layers, wherein each of the one or more coating compositions is substantially free of solvents. When more than one layer is applied, each coating composition (layer) can be the same or different. The disclosed surface coating system is particularly suitable to provide a slip-resistant surface to at least a portion of the surface of an article such as OSB. Preferably, the slip-resistant surface coating system is applied in a single layer.

The present invention also provides a coated article, such as an engineered wood product. Preferably, the coated article includes an engineered wood product and a slip-resistant surface coating system. The slip-resistant surface coating system includes one or more radiation-curable coating compositions and a texturing agent that may be applied in one or more layers, wherein each of the one or more coating compositions is substantially free of solvent. When more than one layer is applied, each coating composition (layer) can be the same or different. The disclosed slip-resistant surface coating system is particularly suitable to prepare a slip-resistant surface for a main surface of an article such as OSB.

The coating compositions that are “substantially free of solvent” refer to compositions that have less than about 5% of solvent by weight, based on the total weight of the composition. Preferably, the coating compositions have less than 1% of solvent by weight. More preferably, the coating compositions have less than 0.5% of solvent by weight. In a preferred embodiment, the disclosed coating compositions include reactive resins and monomers or oligomers that cure to provide a solid coating.

In one embodiment, the slip-resistant surface coating system is applied to the surface of an engineered wood product (panel) and cured with radiation immediately after the panel is removed from the press, before allowing the panel to cool. An exemplary coating composition includes a radiation-curable resin and optionally one or more olefinic monomers, oligomers, or polymers. The coating composition may be applied in one or more layers.

In another embodiment, the coating composition is preferably cured by radiation such as visible light, Ultra Violet light, or Electron Beam, and the like.

In another embodiment, the coating composition is in the form of a UV-curable coating composition. The acrylate oligomers, and olefinic monomers, oligomers, or polymers used in the disclosed surface coating system cure rapidly upon exposure to high intensity UV light resulting in a crosslinked polymer network, i.e., the liquid film will form a solid coating. The solid content of these coating compositions is typically about 100%. The use of a texturing agent in the surface coating system can impart slip-resistance. The untreated engineered wood panels can be slippery, particularly when wet. A worker walking on the roof could have an accident, slip, fall and be injured (even being killed). The use of the disclosed slip-resistant compositions on engineered wood panels can reduce the likelihood of an accident. Slip-resistance can be measured using the coefficient of friction. The coefficient of friction can be measured using ASTM tests F1679 or D4521.

In one embodiment, the coefficient of friction of a panel having the coating system will be at least about 80% of the coefficient of friction of a panel having a screen imprint. Preferably, the coefficient of friction of a panel having the coating system will be at least about 85% of the coefficient of friction of a panel having a screen imprint. More preferably, the coefficient of friction of a panel having the coating system will be at least about 90% of the coefficient of friction of a panel having a screen imprint. Even more preferably, the coefficient of friction of a panel having the coating system will be at least about 95% of the coefficient of friction of a panel having a screen imprint. Most preferably, the coefficient of friction of a panel having the coating system will be at least the same as the coefficient of friction of a panel having a screen imprint.

In a preferred embodiment, the curing is completed immediately after application of the composition to article.

A specific article that may require the slip-resistant surface coating system is an engineered wood panel for use in roofing applications. The disclosed articles can be coated on one or more surfaces with the radiation-curable slip-resistant surface coating system that includes a coating composition and a texturing agent. The slip-resistant surface coating system can be applied as one or more layers. In a preferred embodiment, the slip-resistant surface coating system is applied as single layer.

The texturing agents can be any natural or synthetic coarse material such as ground aggregate particles, rubber particles, plastic (polymeric) particles, inorganic particles, and the like. Non-limiting examples of natural particles can include sand (silica) particles, ground rocks, alumina (Al₂O₃) particles, metal particles (e.g., iron or aluminum), ground ceramic particles, ground sea shells, and the like; or plant materials such as saw dust, wood particles, shell particles such as walnut shells, and the like. Non-limiting examples of synthetic particles include rubber particles, plastic particles such as urea particles, polypropylene particles, polyethylene particles, and the like. Non-limiting examples of aggregate particles include sand (silica) particles, ground rocks, ground ceramic particles, ground sea shells, and the like. The texturing agents can include mixtures of any of the recited materials.

The texturing agents can have particle sizes from about 25 μm to about 1000 μm. Preferably, the texturing agents can have particle sizes from about 50 μm to about 750 μm. More preferably, the texturing agents can have particle sizes from about 75 μm to about 500 μm. Even more preferably, the texturing agents can have particle sizes from about 100 μm to about 300 μm.

The amount of texturing agents on the coated area of a surface of an article of the invention can depend upon the size of the particles, e.g., if relative large particles are used then there may be fewer required. If the composition uses smaller particles then more particles may be used. There can be from about 500 particles to about 4500 particles per square inch. Preferably, the coated area of a surface of an article can have from about 800 particles to about 3600 particles per square inch. More preferably, the coated area of a surface of an article can have from about 1100 particles to about 2400 particles per square inch. Even more preferably, the coated area of a surface of an article can have from about 1400 particles to about 1800 particles per square inch.

Exemplary coating compositions for use in the surface coating system of the invention can include hydrocarbon oligomers such as hydrocarbon acrylate oligomers, and optionally one or more olefinic monomers, oligomers, or polymers. Non-limiting examples of hydrocarbon oligomers and hydrocarbon acrylate oligomers include polyester acrylates, epoxy acrylates, polyether acrylates, urethane acrylates, acrylic acrylates, unsaturated polyesters, and the like. These oligomers are available from companies such as Sartomer Company, Inc, Cytec Industries Inc., Rahn USA Corp., and Bayer MaterialScience LLC.

Exemplary olefinic monomers, oligomers, or polymers for use in the present invention include carbon containing compounds having at least one site of unsaturation. The olefinic monomers, oligomers, or polymers can react, optionally in the presence of an initiator to provide polymeric products. The olefinic compounds may include a mixture of (meth)acrylate esters, allyl ethers, vinyl esters, and vinyl ether monomer materials and the like.

The terms “acrylate esters and methacrylate esters” refer to esters of acrylic acid and esters of methacrylic acid, respectively. They are collectively referred to as (meth)acrylate esters.

Olefins that can be used in the compositions of the invention or to prepare olefinic oligomers, or polymers include but are not limited to olefinic monomers such as (meth)acrylate esters, vinyl ethers, allyl ethers, and combinations thereof.

A preferred olefinic monomer includes tripropylene glycol diacrylate and tripropylene glycol dimethacrylate, and mixtures thereof.

More olefinic monomers include isobornyl (meth)acrylate, isodecyl (meth)acrylate, phenoxyethyl (meth)acrylate, trimethylolpropane tri(meth)acrylate, trimethylolpropane ethoxylate tri(meth)acrylate, tripropylene glycol di(meth)acrylate, hexanediol di(meth)acrylate, tetrahydrofurfuryl (meth)acrylate, pentaerythritol tri(meth)acrylate, pentaerythritol tetra(meth)acrylate, di-(trimethyolpropane tetra(meth)acrylate), beta-carboxyethyl (meth)acrylate, bisphenol α-ethoxylate di(meth)acrylate, ethoxylated neopentyl glycol di(meth)acrylates, propoxylated neopentyl glycol di(meth)acrylates and di-(trimethyolpropane tetra(meth)acrylate) and combinations thereof.

Non limiting examples or (C₁-C₁₅) alcohols can be hydroxymethyl, 1-hydroxyethyl, 2-hydroxyethyl, 1-hydroxypropyl, 2-hydroxypropyl, 3-hydroxypropyl, 1-hydroxybutyl, 4-hydroxybutyl, 1-hydroxypentyl, 5-hydroxypentyl, 1-hydroxyhexyl, 6-hydroxyhexyl, 1,6-dihydroxyhexyl, 1,4-dihydroxybutyl, and the like.

Exemplary olefinic monomers include (meth)acrylate esters of unsubstituted or substituted derivatives of C₁-C₁₅ alcohols, tripropylene glycol, isobornyl alcohol, isodecyl alcohol, phenoxyethyl alcohol, trishydroxyethyl isocyanurate, trimethylolpropane ethoxylate (TMPTA), di trimethylolpropane ethoxylate (diTMPTA), hexanediol, ethoxylated and propoxylated neopentyl glycol, oxyethylated phenol, polyethylene glycol, bisphenol ethoxylate, neopentyl glycol propoxylate, trimethylolpropane, propoxylated glycerol, pentaerythritol, tetrahydrofurfuryl alcohol, β-carboxyethyl alcohol, and combinations thereof.

Another group of olefins which may be employed in practicing the invention are allyl ether monomers. These monomers can also be used as a crosslinkable monomer. Exemplary allyl ether monomers include monomers, each monomer having one or more allyl ether groups. Typically, the allyl ether functional groups of the allyl ether monomers are bonded to a core structural group which is based on a wide variety of polyhydric alcohols. Non-limiting examples of polyhydric alcohols include the alcohols mentioned above in connection with the (meth)acrylate esters, neopentyl glycol, trimethylolpropane, ethylene glycol, propylene glycol, butylene glycol, diethylene glycol, trimethylene glycol, triethylene glycol, trimethylolethane, pentaerythritol, glycerol, diglycerol, 1,4-butanediol, 1,6-hexanediol, 1,4-cyclohexanedimethanol, and the like.

Exemplary allyl ether monomers include hydroxyethyl allyl ether, hydroxypropyl allyl ether, trimethylolpropane monoallyl ether, trimethylolpropane diallyl ether, trimethylolethane monoallyl ether, trimethylolethane diallyl ether, glycerol monoallyl ether, glycerol diallyl ether, pentaerythritol monoallyl ether, pentaerythritol diallyl ether, pentaerythritol triallyl ether, 1,2,6-hexanetriol monoallyl ether, 1,2,6-hexanetriol diallyl ether, and the like. More specific allyl ethers include poly propoxylated and ethoxylated forms of allyl ethers.

Additional exemplary olefinic monomers include vinyl ether monomers. Typically, the vinyl ether monomers have one or more vinyl ether groups. Non-limiting examples of vinyl ether monomers include 4-hydroxybutyl vinyl ether, 1,4-cyclohexane-dimethanol monovinyl ether, 1,4-cyclohexanedimethanol divinyl ether, ethylene glycol monovinyl ether, ethylene glycol divinyl ether, diethylene glycol monovinyl ether, diethylene glycol divinyl ether, triethylene glycol divinyl ether, and the like. More specific vinyl ether monomers which are also include propoxylated and ethoxylated forms of vinyl ether monomers.

A subset of the previously mentioned monomers or oligomers (e.g., hexanediol di(meth)acrylate, trimethylolpropane tri(meth)acrylate and di-trimethyolpropane tetra(meth)acrylate) have multiple (two or more) reactive groups. These monomers or oligomers can function as cross-linking agents. Cross-linking can also occur when the components of the coating composition have active groups. These groups can also react with another component molecule in the composition to link the molecules, or cross link the coating. The term “reactive sites” or “active groups” refers to a group that can react to form a covalent bond linking or chemically joining two or more molecules.

In a preferred embodiment, the amount of olefinic monomers, oligomers, or polymers in the coating compositions of the surface coating system of the invention can be from 0% to 100% by weight based on the total weight of the components in the coating composition. Preferably, the amount of olefinic monomers, oligomers, or polymers can be from about 35 to about 70% by weight based on the total weight of the components. More preferably, the amount of monomers that can be employed in the coating composition is from about 40% to about 60% by weight based on the total weight of the components. Most preferably, the amount of monomers that can be employed in the coating compositions is from about 45% to about 55% by weight, based on the total weight of the components.

Preferably, the acrylate oligomers, and olefinic monomers, oligomers, or polymers can be polymerized using initiators such as free radical initiators. The initiator system is chosen based on the particular type of curing mechanism desired (e.g., UV, Visible, E-beam, cationic, free-radical, etc.). Non-limiting examples of initiators include peroxide compounds, azo compounds, cationic-generating initiators, cleavage type initiator, hydrogen abstraction-type initiators, α-cleavage type initiators and the like. The acrylate oligomers, and olefinic monomers or oligomers are preferably cured by radiation such as visible light, Ultra Violet light, or Electron Beam, and the like.

Preferred compositions for coating the articles or for use in the method of the invention optionally include an initiator system such as a UV photoinitiator system.

In one embodiment, the UV photoinitiator system generates free radicals in response to a particular wavelength range of light to initiate a free radical reaction, thereby curing the coating. Examples of free-radical-generating photoinitiators include, azo compounds, cationic-generating photoinitiators, cleavage type initiator, hydrogen abstraction-type photoinitiators, or α-cleavage type photoinitiator and the like.

If desired, the coating composition may also include a co-initiator or photoinitiator synergist. Non-limiting examples of co-initiators include (1) tertiary aliphatic amines like methyl diethanol amine and triethanol amine; (2) aromatic amines like amylparadimethylaminobenzoate, 2-n-butoxyethyl-4-(dimethylamino) benzoate, 2-(dimethylamino)ethylbenzoate, ethyl-4-(dimethylamino)benzoate, and 2-ethylhexyl-4-(dimethylamino)benzoate; (3) (meth)acrylated amines like Ebecryl™ 7100 and Uvecryl™ P104 and P115, all from UCB RadCure Specialties; and (4) amino-functional acrylate or methacrylate resin or oligomer blends such as Ebecryl™ 3600 or Ebecryl™ 3703, both from UCB RadCure Specialties. Combinations of the above four categories of amines may also be used.

Preferably, the amount of photoinitiator present in the coating compositions can be from about 0.2 to about 15 wt. % of the non-volatile components. More preferably, the photoinitiator can be from about 0.5 to about 10 wt. %, and most preferably the photoinitiator can be from about 0.75 to about 5 wt. % of the non-volatile components. The photoinitiator system may include other agents such as a co-initiator or photoinitiator synergist that aids the photochemical initiation reaction.

Non-limiting examples of cationic-generating photoinitiators include super acid-generating photoinitiators, such as triaryliodonium salts, triarylsulfonium salts and the like. A particularly useful triarylsulfonium salt is triphenyl sulfonium hexafluorophosphate.

Non-limiting examples of cleavage type photoinitiators include, α,α-diethoxyacetophenone (DEAP); dimethoxyphenylacetophenone (Irgacure™ 651); hydroxycyclo-hexylphenylketone (Irgacure™ 184); 2-hydroxy-2-methyl-1-phenylpropan-1-one (Darocur™ 1173); Irgacure™ 1700, and Darocur™ 4265 all from Ciba Corporation, Ardsley, N.Y. Irgacure™ 1700 is a 25:75 blend of bis-(2,6-dimethoxybenzoyl)-2,4,4-trimethylpentyl phosphine oxide and 2-hydroxy-2-methyl-1-phenylpropan-1-one. Darocur™4265 is a 50:50 blend of 2-hydroxy-2-methyl-1-phenylpropan-1-one and 2,4,6-trimethylbenzoyldiphenylphosphine oxide (TPO). Lucirin TPO photoinitiator (2,4,6-trimethylbenzoyl-diphenylphosphine oxide) of BASF Corporation and KIP™ 100 photoinitiator (a mixture of 70% oligo 2-hydroxy-2-methyl-[4-(1-methylvinyl)phenyl]propan-1-one and 30% 2-hydroxy-2-methyl-1-phenylpropan-1-one) available from Sartomer (Exton, Pa.) are also preferred.

Non-limiting examples of hydrogen abstraction-type photoinitiators include benzophenone, substituted benzophenones (e.g., Escacure™ TZT of Fratelli-Lamberti) and other diaryl ketone such as xanthones, thioxanthones, Michler's ketone, benzil, quinones, and substituted derivatives of all of the above.

Irgacure™ 500 is a mixture of Irgacure™ 184 and benzophenone, in a 1:1 ratio, and is a good example of a mixture of an α-cleavage type photoinitiator and a hydrogen abstraction-type photoinitiator. Other mixtures of photoinitiators may also be used in the coating composition. Preferred photoinitiators include Darocur™ 1173, KIP™ 100, benzophenone, and Irgacure™ 184. Camphorquinone is one example of a compound that can be used when one desires to cure a coating composition with visible light.

Many coating compositions which can be cured by UV or visible light can also be cured with an electron beam. Techniques and devices for curing a coating composition using an electron beam are known in the art. Typically, these techniques do not require a photoinitiator for electron beam cure of the coating.

For coating compositions having olefinic monomers, oligomers, or polymers with a mixture of (meth)acrylate, allyl ether, and vinyl ether functional groups, a combination of curing procedures can be used. For example, a coating composition having olefinic monomers, oligomers, or polymers used in the coating system with both (meth)acrylate and vinyl ether functional groups can include an α-cleavage type and/or hydrogen abstraction type photoinitiator for the (meth)acrylate groups and a cationic-generating photoinitiator for the vinyl ether groups.

Other components of the coating compositions include those typically used in paint formulations, such as pigments, extenders, fillers, thickeners, biocides, mildewcides, surfactants, dispersants, defoamers, and the like. Exemplary additives for use in coating compositions are described in Koleske et al., Paint and Coatings Industry, April, 2003, pages 12-86.

The surface coating system can be applied to the engineered wood product using any method known in the art. Non-limiting examples of application methods include rolling using smooth or etched rollers or wheels, gravity feed or pressure feed, i.e., allowing a continuous flow from an applicator directly to the surface of a substrate, brushes, brush spatter application, and the like. The coating system can be applied by first spraying the coating composition and sprinkling the texturing agent before curing the coating composition. The preferred method for practicing the invention is applying the surface coating system to an engineered wood product (panel) is using a rolling device, such as a knurled roll. The surface coating system can be applied to the complete surface or to a portion of the surface, such as stripes or a pattern, e.g., a company logo, as desired by the wood panel producer. Thus, it is not required that the entire substrate surface be coated.

Exemplary dry film thickness (DFT) of the coating composition on engineered wood products is in the range of, but not limited to about 0.5 mil to about 5 mil (about 0.00127 cm to about 0.0127 cm), more preferably about 0.6 to about 1 mil (about 0.00152 cm to about 0.00254 cm), and most preferably about 0.7 to about 0.8 mil (about 0.00178 cm to about 0.0203 cm).

Exemplary optional fillers, extenders or inert ingredients for use in coating compositions of the present invention include, for example, clay, glass beads, calcium carbonate, talc, silicas, organic fillers, and the like. Fillers extend, lower the cost of, alter the appearance of, or provide desirable characteristics to the composition before and after curing.

The coating compositions of the invention may also include other ingredients that modify properties of the composition as they are stored, handled, or applied, and at other or subsequent stages. Optional performance enhancing additives may be employed in this invention as required in amounts effective to upgrade the performance of the cured coating and the coating composition. Desirable performance characteristics of the coating include chemical resistance, abrasion resistance, hardness, gloss, reflectivity, appearance, or combinations of these characteristics, and other similar characteristics.

Preferred coating compositions have improved e.g., lower, volatile organic content (VOC). Specifically, preferred coating compositions of the invention have a VOC of less than about 1%, based on the total weight of the coating composition. More preferably, the coating composition has a VOC of less than about 0.5%, based on the total weight of the coating composition. Most preferably, the coating composition has a VOC of less than about 0.05% based on the total weight of the coating composition.

The invention will be described by the following non-limiting examples. All amounts are parts by weight unless otherwise indicated.

### EXAMPLES

### Example 1

### Preparation of Slip-Resistant Coating System

A resin mixture is prepared in a stainless steel reactor. The resin mixture includes tripropylene glycol diacrylate (Sartomer SR306, 134.234 parts), a difunctional bisphenol A epoxy acrylate, having an additional 20% of tripropylene glycol diacrylate (Sartomer CN-120 A80, 77.838 parts), and a saturated polyester resin (442.397 parts). The resin mixture is blended and initiators Darocur 1173 (33.270 parts), Lucirin TPO (1.442 parts) and Irgacure 369 (0.591 parts); a stabilizer, butylated hydroxy toluene (BHT, 0.251 parts); and a defoamer Lithene PL (air release agent, 1.442 parts) are added. The resin mixture is stirred until all ingredients are dissolved. This is followed by the addition of extenders, Nytal 300 (73.656 parts), and Omyacarb 3 (110.484 parts). The mixture is stirred for about 15 additional minutes. The polymer particles (Plasti-Grit Type II, 21.544 parts, 100) are added followed by a colorant (Black UV Paste (9B1), 8.375 parts).

### Example 2

### Application of Slip-Resistant Coating

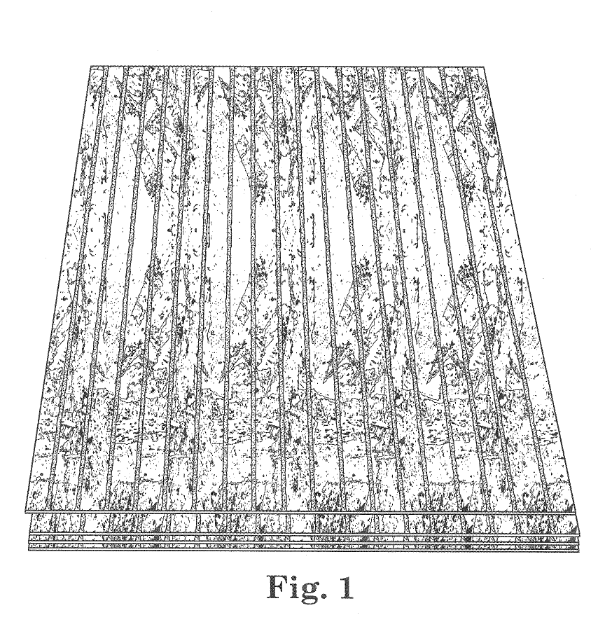

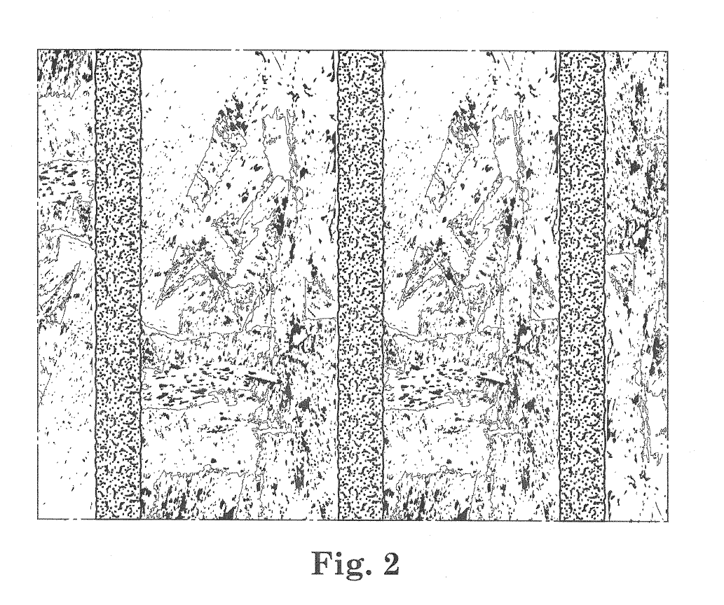

The slip-resistant coating system prepared in Example 1 is applied to OSB panels (2 ft. by 8 ft.) using a metal knurled roller. The stripes are about ¼ inch wide with about 1 inch of open space in between each stripe. The coating composition is immediately cured using 300 watt/inch mercury vapor lamp to provide the slip-resistant surface. The coated area of the surface is estimated to have about 1600 particles pre square inch. FIGS. 1 and 2 illustrate the application of the coating composition of the invention on OSB panels (2 ft. by 8 ft.).

All references cited herein are expressly incorporated herein by reference in their entirety into this disclosure. In the case of any inconsistencies, the present disclosure, including any definitions therein will prevail. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure and the claims shown below are not limited to the illustrative embodiments set forth herein.

What is claimed is:

1. A method for preparing a slip-resistant surface on an engineered wood panel comprising;
(a) providing an engineered wood product;
(b) applying a slip-resistant surface coating system comprising a radiation-curable coating composition and a texturing agent to at least a portion of at least one surface of the wood panel; and
(c) curing the coating composition.

2. The method of claim 1, wherein the coating composition is substantially free of solvents or carriers.

3. The method of claim 1, wherein the radiation is from a UV light.

4. The method of claim 1, wherein the radiation is from an electron beam.

5. The method of claim 1, wherein the engineered wood panel is an oriented strand board or plywood panel.

6. The method of claim 5, wherein the engineered wood panel is an oriented strand board panel.

7. The method of claim 1, wherein the engineered wood panel is hot when the coating composition is applied.

8. The method of claim 7, wherein the temperature of the engineered wood panel is from about 24° C. (75° F.) to about 149° C. (300° F.).

9. The method of claim 8, wherein the temperature of the engineered wood panel is from about 52° C. (125° F.) to about 135° C. (275° F.).

10. The method of claim 9, wherein the temperature of the engineered wood panel is from about 66° C. (150° F.) to about 121° C. (250° F.).

11. The method of claim 10, wherein the temperature of the engineered wood panel is from about 93° C. (200° F.) to about 107° C. (225° F.).

12. The method of claim 1, wherein the texturing agent is rubber particles, plastic particles, sand (silica) particles or walnut shell particles.

13. The method of claim 12, wherein the texturing agent is urea particles, or polypropylene particles.

14. The method of claim 13, wherein the texturing agent is urea particles.

15. The method of claim 1, wherein the texturing agent has particle sizes from about 25 μm to about 1000 μm.

16. The method of claim 15, wherein the texturing agent has particle sizes from about 50 μm to about 750 μm.

17. The method of claim 16, wherein the texturing agent has particle sizes from about 75 μm to about 500 μm.

18. The method of claim 17, wherein the texturing agent has par particle sizes from about 100 μm to about 300 μm.

19. The method of claim 1, wherein the amount of olefinic monomers, oligomers, or polymers is from about 35 to about 70% by weight based on the total weight of the components.

20. The method of claim 19, wherein the amount of olefinic monomers, oligomers, or polymers is from about 40% to about 60% by weight based on the total weight of the components.

21. The method of claim 20, wherein the amount of olefinic monomers, oligomers, or polymers is from about 45% to about 55% by weight

22. The method of claim 1, wherein the coating composition comprises less than about 5% of solvent by weight, based on the total weight of the composition.

23. The method of claim 22, wherein the coating composition comprises less than about 1% of solvent by weight.

24. The method of claim 23, wherein the coating composition comprises less than about 0.5% of solvent by weight.

25. The method of claim 1, wherein the coating composition and the texturing agent are mixed together.

26. A coated article, comprising;
(a) an engineered wood panel; and
(b) a slip-resistant surface coating system comprising a radiation-curable coating composition and a texturing agent;
wherein the coating composition is radiation-curable and substantially free of solvent.

27. The article of claim 26, wherein at least a portion of a major surface is coated with the slip-resistant surface coating composition.

28. The article of claim 27, wherein the texturing agent is ground aggregate particles, rubber particles, plastic (polymeric) particles, inorganic particles, or mixtures thereof.

29. The article of claim 28, wherein the texturing agent is urea particles, or polypropylene particles.

30. The article of claim 29, wherein the texturing agent is urea particles.

31. The article of claim 26, wherein the texturing agent has particle sizes from about 25 μm to about 1000 μm.

32. The article of claim 31, wherein the texturing agent has particle sizes from about 50 μm to about 750 μm.

33. The article of claim 32, wherein the texturing agent has particle sizes from about 75 μm to about 500 μm.

34. The article of claim 33, wherein the texturing agent has particle sizes from about 100 μm to about 300 μm.

35. The article of claim 26, wherein the amount of olefinic monomers, oligomers, or polymers is from about 35 to about 70% by weight based on the total weight of the components.

36. The article of claim 35, wherein the amount of olefinic monomers, oligomers, or polymers is from about 40% to about 60% by weight based on the total weight of the components.

37. The article of claim 36, wherein the amount of olefinic monomers, oligomers, or polymers is from about 45% to about 55% by weight.

38. The article of claim 26, wherein the engineered wood product is oriented strand board or plywood.

39. The article of claim 38, wherein the engineered wood product is oriented strand board.

40. The article of claim 26, wherein the coating composition and the texturing agent are mixed together prior to application to the article.

41. A slip-resistant surface coating system comprising
(a) a radiation-curable coating composition; and
(b) a texturing agent;
wherein the coating composition is substantially free of solvent.
